(19) United States
(12) Patent Application Publication
(10) Pub. No.: US 2023/0361391 A1
(43) Pub. Date: Nov. 9, 2023

(54) CYLINDRICAL NON-AQUEOUS ELECTROLYTE SECONDARY CELL

(71) Applicant: SANYO Electric Co., Ltd., Kadoma-shi, Osaka (JP)

(72) Inventors: Yuichiro Okada, Tokushima (JP); Katsuya Ito, Tokushima (JP); Shuichi Yamashita, Tokushima (JP); Yuki Iida, Tokushima (JP)

(73) Assignee: SANYO Electric Co., Ltd., Kadoma-shi, Osaka (JP)

(21) Appl. No.: 18/028,644

(22) PCT Filed: Oct. 5, 2021
(86) PCT No.: PCT/JP2021/036735

§ 371 Date: Mar. 27, 2023

(30) Foreign Application Priority Data
Oct. 13, 2020 (JP) 2020-172569

(51) Int. Cl. H01M 50/107; H01M 50/171; H01M 50/124

(52) U.S. Cl. CPC H01M 50/107; H01M 50/171; H01M 50/1243

(57) ABSTRACT

Provided is a secondary battery in which corrosion of an exterior body is stably suppressed. A non-aqueous electrolyte secondary battery according to an embodiment of the present disclosure comprises: an exterior body having a bottomed cylindrical shape and having a grooving portion in an opening portion; an electrode body and a non-aqueous electrolyte housed in the exterior body; and a sealing body caulked and fixed between the grooving portion and an opening end in the opening, wherein in a portion from the grooving portion of the inner surface of the exterior body to the open end portion, a powder of at least one among compounds selected from the group consisting of hydroxides, oxides, and carbonates is present.

### TECHNICAL FIELD

The present disclosure relates to a cylindrical non-aqueous electrolyte secondary battery.

### BACKGROUND

A cylindrical non-aqueous electrolyte secondary battery includes a cylindrical outer housing having a bottom, which contains an electrode assembly and a non-aqueous electrolyte. The interior of the battery is sealed with a sealing structure caulked and fixed between a groove portion and an open end in an opening portion of the outer housing. During production of such batteries, the non-aqueous electrolyte injected into the outer housing may remain adhered to the opening portion of the outer housing. The non-aqueous electrolyte remaining in a region of the outer housing above the groove portion where the sealing structure is to be caulked and fixed may react with water entering externally to generate hydrogen fluoride, resulting in corrosion of the outer housing. Patent Document 1 discloses a technique of enhancing airtightness of a battery by applying a sealant including an alkaline compound having an amino group in pitches to a region of an inner surface of the outer housing located above the groove portion.

### CITATION LIST

### Patent Literature

### SUMMARY

### Technical Problem

The technique disclosed in Patent Document 1, however, has a problem in that an alkaline compound such as butylamine is likely to volatilize and would not provide stable advantages, leaving plenty of room for improvement.

The present disclosures is therefore aimed toward providing a secondary battery that enables reliable inhibition of corrosion of the outer housing.

### Solution to Problem

In accordance with one aspect of the present disclosure, a non-aqueous electrolyte secondary battery includes a cylindrical outer housing having a bottom, the outer housing including an opening portion having a groove portion, an electrode assembly and a non-aqueous electrolyte contained in the outer housing, and a sealing structure caulked and fixed between the groove portion and an opening end in the opening portion. A region of an inner surface of the outer housing between the groove portion and the opening end includes powder of one or more compounds selected from a group consisting of hydroxide, oxide, and carbonate.

### Advantageous Effects

The non-aqueous electrolyte secondary battery according to the present disclosure enables stable inhibition of corrosion of the outer housing.

### BRIEF DESCRIPTION OF DRAWINGS

FIG. 1 is a vertical cross sectional view of an example cylindrical non-aqueous electrolyte secondary battery of an embodiment.

FIG. 2 is an enlarged view of a region in the vicinity of an opening portion of the outer housing in FIG. 1.

### DESCRIPTION OF EMBODIMENTS

A cylindrical secondary battery according to an example embodiment of the present disclosure will be described by reference to the drawings. In the following description, specific shapes, materials, numerical values, directions, and the like are examples for facilitating understanding of the present invention, and may be modified as appropriate in accordance with specifications of the cylindrical secondary battery. It is further assumed that features of a plurality of embodiments and modification examples included in the following description may be used in appropriate combinations.

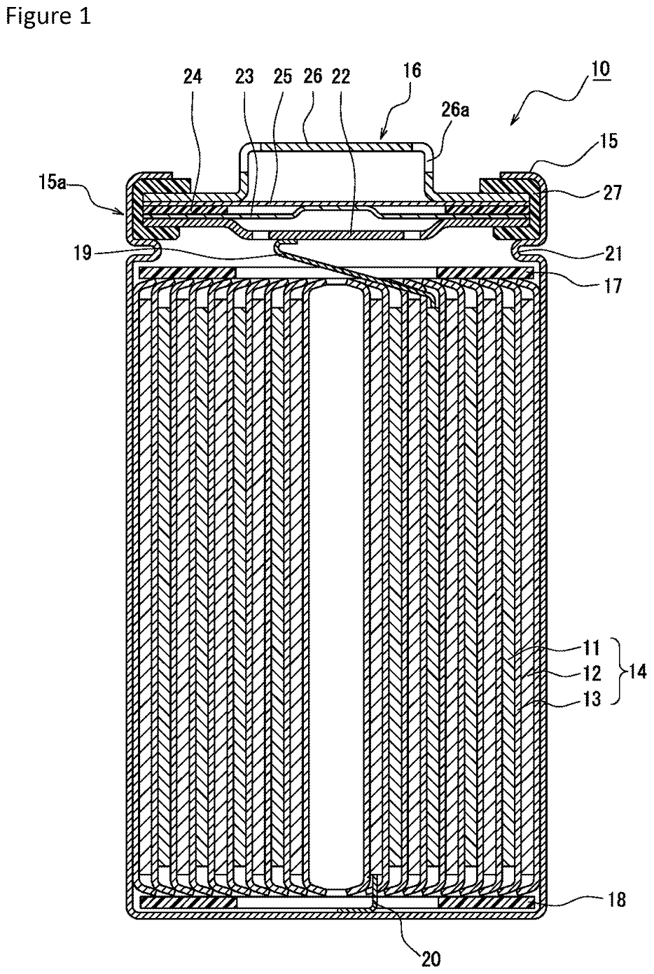

FIG. 1 is a vertical cross sectional view of a secondary battery 10 according to an example embodiment. The secondary battery 10 illustrated in FIG. 1 includes an outer housing 15 containing an electrode assembly 14 and a non-aqueous electrolyte (not shown). In the following, for convenience of explanation, a direction toward a sealing structure 16 indicates “upward” directed to a top and a direction toward the bottom of the outer housing 15 indicates “downward” directed to a bottom.

The electrode assembly 14 has a rolled structure including a positive electrode 11 and a negative electrode 12 wound with a separator 13 between the positive electrode 11 and the negative electrode 12. The positive electrode 11 includes a belt-shape positive electrode current collector and positive electrode mixture layers disposed on respective opposite sides of the positive electrode current collector. The positive electrode current collector may be a metal foil such as aluminum or a film having such a metal disposed on a top layer, for example.

The positive electrode mixture layer is produced by, for example, applying a positive electrode mixture slurry including a positive electrode active material, a conductive agent, a binder material, and a solvent such as N-methyl-2-pyrrolidone (NMP), on the respective opposite sides of the positive electrode current collector and thereafter drying and compressing the applied membranes. Examples of the positive electrode active material include a lithium transition metal composite oxide containing a transition metal element such as Co, Mn, or Ni. Examples of the conductive agent include a carbon material, such as carbon black (CB), acetylene black (AB), Ketjenblack, and graphite. Examples of the binding material include a fluorine-containing resin, such as polytetrafluoroethylene (PTFE) and polyvinylidene fluoride (PVdF), a polyacrylonitrile (PAN), polyimide (PI), acrylic resin, and polyolefin, for example.

The negative electrode 12 includes a belt-shape negative electrode current collector and negative electrode mixture layers disposed on respective opposite sides of the negative electrode current collector. The negative electrode current collector may be a metal foil such as copper or a film having such a metal disposed on a top layer, for example.

The negative electrode mixture layer is produced by applying a negative electrode mixture slurry including a negative electrode active material, a binder material, and water, for example, on the respective opposite sides of the negative electrode current collector and thereafter drying and compressing the applied membranes. Examples of the negative electrode active material include a carbon material such as natural graphite or artificial graphite, a metal such as Si or Sn which forms an alloy with Li, and an alloy or oxide containing these metals. Examples of the binder include styrene-butadiene rubber (SBR), CMC or its salt, polyacrylic acid or its salt, and polyvinyl alcohol, for example.

The separator 13 may be an ion-permeable and insulating porous sheet, for example. Specific examples of the porous sheet include a microporous thin film, woven fabric, and non-woven fabric. Suitable examples of the material for the separator 13 include an olefin resin such as polyethylene and polypropylene.

A non-aqueous solvent (organic solvent) of the non-aqueous electrolyte contained in the outer housing 15 may be carbonates, lactones, ethers, or ketones, for example, and may be mixtures of two or more of these solvents. The mixtures of two or more solvents preferably include mixture solvents of cyclic carbonates and chain carbonates. For example, the cyclic carbonate may include ethylene carbonate (EC), propylene carbonate (PC), and butylene carbonate (BC). The chain carbonate may include dimethyl carbonate (DMC), ethyl methyl carbonate (EMC), and diethyl carbonate (DEC), for example. An electrolyte salt of the non-aqueous electrolyte may be LiPF₆, LiBF₄, or LiCF₃SO₃, for example, and mixtures thereof. The dissolution amount of the electrolyte salt with respect to the non-aqueous solvent is 0.5 to 2.0 mol/L, for example.

The sealing structure 16 seals the opening portion of the outer housing 15 to thereby hermetically seal the interior of the secondary battery 10. Insulating plates 17 and 18 are disposed on top and bottom of the electrode assembly 14, respectively. A positive electrode lead 19 extends upward through a through hole of the insulating plate 17 and is welded to an undersurface of a filter 22 that is a bottom plate of the sealing structure 16. The secondary battery 10 includes, as a positive electrode terminal, a cap 26 that is a top plate of the sealing structure 16 electrically connected with the filter 22. A negative electrode lead 20 extends toward the bottom of the outer housing 15 thorough a through hole of the insulating plate 18 and is welded to a bottom inner face of the outer housing 15. The outer housing 15 in the secondary battery 10 functions as a negative electrode terminal.

The outer housing 15 is cylindrical with a bottom, and has an opening portion 15a having a groove portion 21. The outer housing 15 is made of a metal, for example. The groove portion 21 supports the sealing structure 16 with its top face. The outer housing 15 contains the electrode assembly 14 and the non-aqueous electrolyte in a region under the groove portion 21. The groove portion 21 is preferably present annularly along the circumference of the outer housing 15. The groove portion 21 may be formed by externally pressing side faces of the outer housing 15, for example.

The sealing structure 16 includes a filter 22, a lower vent member 23, an insulating member 24, an upper vent member 25, and the cap 26 stacked in sequence from the side of the sealing structure 16 close to the electrode assembly 14. These members forming the sealing structure 16 each have a disc shape or an annular shape and the members other than the insulating member 24 are electrically connected with each other. The lower vent member 23 and the upper vent member 25 are connected with each other at their center portions, and the insulating member 24 is disposed between the lower vent member 23 and the upper vent member 25 at their edge portions. An increase in the internal pressure of the battery caused by abnormal heating, for example, ruptures the lower vent member 23. This causes the upper vent member 25 to expand toward the cap 26 and separate from the lower vent member 23, thereby interrupting electrical connection between the upper vent member 25 and the lower vent member 23. Further increase in the internal pressure causes the upper vent member 25 to rupture to allow a gas to discharge from an opening 26a of the cap 26.

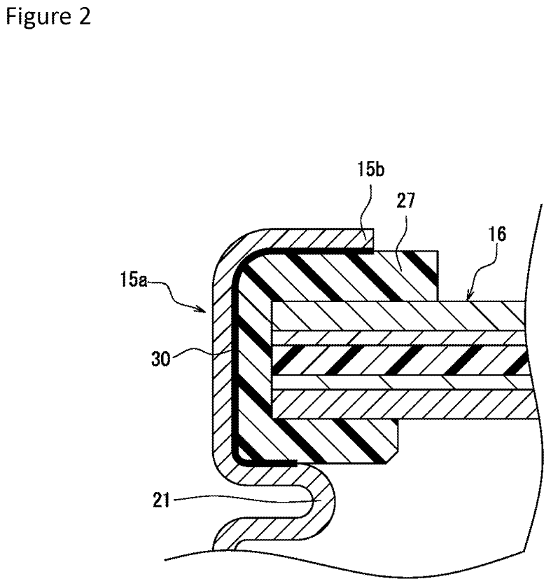

Referring now to FIG. 2, hermetical sealing in the opening portion 15a of the secondary battery 10 will be described. FIG. 2 is an enlarged view of a region near the opening portion 15a of the outer housing 15.

The sealing structure 16 is fixed, by caulking, between the groove portion 21 and an opening end 15b in the opening portion 15a of the outer housing 15. More specifically, the sealing structure 16 is compressed and fixed between the groove portion 21 and the opening end 15b that is an inwardly-bent upper end of the outer housing 15, via a gasket 27. The gasket 27 is a flexible insulating member, and electrically isolates the sealing structure 16 that is a positive electrode terminal and the outer housing 15 that is a negative electrode terminal from each other. The gasket 27 is compressed vertically to secure airtightness or hermetical sealing within the secondary battery 10. Any compressible insulating material, such as polypropylene (PP), polyphenylene sulfide (PPS), a polyethylene (PE), polybutylene terephthalate (PBT), perfluoroalkoxyalkane (PFA), polytetrafluoroethylene (PTFE), and polyamide (PA), may be used as a material for the gasket 27.

Powder of one or more compounds selected from a group consisting of hydroxide, oxide, and carbonate (hereinafter referred to as a “compound” or “compounds”) is present in a region of the inner face of the outer housing 15 between the groove portion 21 and the opening end 15b (hereinafter referred to as an “opening upper region” 30). This allows hydrogen fluoride generated by reaction of a non-aqueous electrolyte adhered to the inner face of the opening portion 15a with water entering from the opening end 15b, to be neutralized with the compounds present in the opening upper region 30, thereby inhibiting corrosion of the outer housing 15. Also, the compounds, which do not volatilize for a long preservation period, can reliably inhibit corrosion of the outer housing.

The ratio of (molecular weight)/(sum of the number of valences of cation) in the compound is preferably 60 or less. This can reduce the required amount (mass) of the compounds present in the opening upper region 30. Here, the sum of the number of valences of cation refers to summation of the number of valences of all cations forming the compound. For example, the sum of the number of valences of cations in Al₂O₃, which includes two Al³⁺'s, equals to six.

The compound preferably includes any of aluminum hydroxide (Al(OH)₃), magnesium hydroxide (Mg(OH)₂), aluminum oxide (Al₂O₃), magnesium oxide (MgO). lithium carbonate (Li₂CO₃), or sodium carbonate (Na₂CO₃). These have low volatility and low toxicity, and are therefore suitable for use in the secondary battery 10. In particular, the compound preferably includes Al(OH)₃ or Mg(OH)₂, which has a small specific gravity and, as will be described below, does not cause sedimentation during production of a coating solution including the compound and is easy to handle.

The required amount of the compound present in the opening upper region 30 is computable by estimation of the amount of hydrogen fluoride to be generated based on the amount of the non-aqueous electrolyte assumed to be adhered to the opening portion 15a of the outer housing 15. In the outer housing 15 having a cylindrical shape with a bottom, with a diameter φ of 18 mm and a height of 65 mm, for example, presence of 0.5 mg to 40 mg of the compound, more preferably 1 mg to 20 mg of the compound, and particularly preferably 3 mg to 14 mg of the compound, in the opening portion can neutralize hydrogen fluoride to thereby inhibit corrosion of the outer housing 15.

To allow the compound to be present in the opening upper region 30, a coating solution including the compound may be applied to the opening upper region 30. The coating solution is produced by mixing the compound in a solvent which may be xylene, ethylbenzene, or toluene, for example. Further, as an additive to the coating solution, rubber-based polymer represented by 1,2-polybutadiene that is conventionally used as a sealant, pitch, asphalt, or vinyl polymer, silicon-based polymer, acrylic polymer, urethane polymer, and fluorocarbon polymer or combinations of two or more of these substances may be used. The ratio of the compound in the coating solution is preferably 0.5 mass % to 20 mass %, more preferably 1 mass % to 10 mass %, and particularly preferably 3 mass % to 7 mass %, for example. These ranges enable appropriate application of the coating solution to the opening upper region 30. A particularly preferable ratio of the compound in the coating solution is approximately 5 weight % in terms of viscosity, sedimentation, and an application amount, and also in view of enhancement of operability. After application of the coating solution, a heating treatment may be applied to dry the coating solution. The heating treatment can be performed at 100° C. to 200° C. for 30 to 300 minutes.

An example method of producing the secondary battery 10 will be described. First, the insulating plates 17 and 18 are respectively placed on top and bottom of the electrode assembly 14 and the assembly is housed in the outer housing 15. The negative electrode lead 20 is then welded to the bottom of the outer housing 15. The groove portion 21 is formed in the opening portion 15a of the outer housing 15 by pressing, and thereafter, a coating solution is applied to a region of the opening portion 15a above the groove portion 21. After leaving the assembly in this state for 30 minutes at room temperatures, the gasket 27 is placed above the groove portion 21. Thereafter, the sealing structure 16 is welded to the positive electrode lead 19 and heating treatment is performed at 110° C. for 150 minutes. An appropriate amount of non-aqueous electrolyte is further injected into the outer housing 15. Then, the sealing structure 16 is caulked and fixed between the opening end 15b of the outer housing 15 and the groove portion 21, via the gasket 27, thereby producing a cylindrical non-aqueous electrolyte secondary battery.

### EXAMPLES

Examples of the present disclosure will be described below; however, the present disclosure is not limited to these examples.

### Example 1

### [Production of Positive Electrode]

Lithium cobalt oxide expressed as LiCoO₂ was used as a positive electrode active material. First, 100 parts by mass of the positive electrode active material, 1 part by mass of acetylene black (AB) or a conductive agent, and 1 part by mass of polyvinylidene fluoride (PVDF) or a binder were mixed. An appropriate amount of N-methyl-2-pyrrolidone (NMP) was further added to the mixture to prepare a positive electrode mixture slurry. Then, the positive electrode mixture slurry was applied to the opposite sides of a positive electrode current collector made of an aluminum foil. The resulting positive electrode current collector was then dried in a drier, and thereafter cut into a predetermined electrode size and rolled with a roller to form a positive electrode in a belt shape. Further, a blank portion free of an active material was formed at one end of the positive electrode in the longitudinal direction and an aluminum positive electrode lead was fixed to the blank portion by ultrasonic welding.

### [Production of Negative Electrode]

Natural graphite powder was used for a negative electrode active material. First, 100 parts by mass of the negative electrode active material, 1 part by mass of styrene-butadiene rubber (SBR) or a binder, and 1 part by mass of carboxymethylcellulose (CMC) or a thickener were mixed, and an appropriate amount of water was further added to the mixture to prepare a negative electrode mixture slurry. Then, the negative electrode mixture slurry was applied to the opposite sides of a negative electrode current collector made of a copper foil. The resulting negative electrode collector was then dried in a drier, and thereafter cut into a predetermined electrode size and rolled with a roller to form a positive electrode in a belt shape. Further, a blank portion free of an active material was formed at one end of the negative electrode in the longitudinal direction and an aluminum positive electrode lead was fixed to the blank portion by ultrasonic welding.

### [Production of Electrode Assembly]

The positive electrode and the negative electrode that were produced were wound via a separator into a scroll to produce a wound electrode assembly. At this time, an end of the positive electrode to which a positive electrode lead is connected was positioned close to the inner circumference (winding start) and an end of the negative electrode to which a negative electrode lead is connected was positioned close to the outer circumference (wining end). The separator that was used includes a heat-resisting layer having a dispersed filler of polyamide and alumina disposed on one side of a polyethylene porous film.

### [Preparation of Non-Aqueous Electrolytic Solution]

Ethylene carbonate (EC), ethyl methyl carbonate (EMC), and diethyl carbonate (DEC) were mixed at a volume ratio of EC:EMC:DMC=3:3:4, to form a mixture solvent, and 1 mol/L of LiPF₆ was added to the mixture solvent to prepare a non-aqueous electrolytic solution.

### [Preparation of Coating Solution]

A coating solution was prepared by mixing a solvent containing 90 g of xylene and 5 g of 1,2-polybutadiene with 5 g of aluminum hydroxide (Al(OH)₃) powder.

### [Production of Secondary Battery]

A cylindrical metal can having a diameter φ 18 mm and a height of 65 mm was used as an outer housing. An electrode assembly having insulating plates on top and bottom respectively was stored in the outer housing, and thereafter the negative electrode lead was welded to the bottom of the outer housing. A groove portion was then formed in an opening portion of the outer housing by pressing and thereafter the coating solution was applied to a region of the opening portion above the groove portion. After leaving the coating solution for 30 minutes at room temperature, a gasket was placed above the groove portion. A sealing structure was then welded to the positive electrode lead, and a heating treatment was performed at 110° C. for 150 minutes, and 6.5 g of the non-aqueous electrolyte was injected into the outer housing. Thereafter, the opening portion of the outer housing was sealed with the sealing structure by caulking via the gasket, thereby producing the cylindrical non-aqueous electrolyte secondary battery. The produced secondary battery bad nominal voltage of 4.2 V and rated capacity of 1950 mAh. Five secondary batteries were produced in this manner.

### Example 2

A battery was produced in a manner similar to Example 1 except that, to apply a compound to the outer housing, the coating solution was prepared using magnesium hydroxide (Mg(OH)₂) powder in place of Al(OH)₃ powder.

### Example 3

A battery was produced in a manner similar to Example 1 except that, to apply a compound to the outer housing, the coating solution was prepared using aluminum oxide (Al₂O₃) powder in place of Al(OH)₃ powder.

### Example 4

A battery was produced in a manner similar to Example 1 except that, to apply a compound to the outer housing, the coating solution was prepared using magnesium oxide (MgO) powder in place of Al(OH)₃ powder.

### Example 5

A battery was produced in a manner similar to Example 1 except that, to apply a compound to the outer housing, the coating solution was prepared using lithium carbonate (Li₂CO₃) powder in place of Al(OH)₃ powder.

### Example 6

A battery was produced in a manner similar to Example 1 except that, to apply a compound to the outer housing, the coating solution was prepared using sodium carbonate (Na₂CO₃) powder in place of Al(OH)₃ powder.

### Comparative Example 1

A battery was produced in a manner similar to Example 1 except that, in applying a compound to the outer housing, the coating solution was prepared only with a mixture of 95 g of xylene and 5 g of polybutadiene, and without mixing Al(OH)₃ powder in the coating solution.

### Comparative Example 2

A battery was produced in a manner similar to Example 1 except that, to apply a compound to the outer housing, the coating solution was prepared using a mixture 10 g of butylamine (C₄H₁₁N) liquid in place of the Al(OH)₃ powder, 85 g of xylene, and 5 g of polybutadiene.

### [Evaluation of Corrosion Occurrence by Accelerated Test]

The batteries in Examples and Comparative Examples were charged with constant. current of 0.3 C at the temperature of 25° C. until the battery voltage reached 4.2 V, and then charged with constant voltage of 4.2 V until the current value reached 0.02 C. Thereafter, the batteries were left for 30 days at the temperature of 75° C. and the humidity of 90%, and then an accelerated fest for corrosion of the outer housing was performed. An X-ray Computed Tomography (CT) device was used to perform 360° tomographic observation of the batteries after the accelerated fest and occurrence of corrosion of the outer housing in a region above the groove portion was checked. Evaluation was based on the number of batteries in which corrosion occurred.

Evaluation results for Examples and Comparative Examples are shown in Table 1. Table 1 further shows the type of mixed compound, and the molecular weight, the total number of valences of cation, and the (molecular weight)/(total number of valences of cation) of the compound.

TABLE 1

| | COMPOUND | | | | |
|---|---|---|---|---|---|
| | | | | MOLECULAR | |
| | | | TOTAL | WEIGHT/TOTAL | EVALUATION |
| | | | NUMBER OF | NUMBER OF | NUMBER OF |
| | | MOLECULAR | VALENCES OF | VALENCES OF | OCCURRENCE |
| | TYPE | WEIGHT | CATION | CATION | OF CORROSION |
| EXAMPLE 1 | Al(OH)₃ | 78 | 3 | 26 | 0/5 |
| EXAMPLE 2 | Mg(OH)₂ | 58.3 | 2 | 29.2 | 0/5 |
| EXAMPLE 3 | Al₂O₃ | 102 | 6 | 17 | 0/5 |
| EXAMPLE 4 | MgO | 40.3 | 2 | 20.2 | 0/5 |
| EXAMPLE 5 | Li₂CO₃ | 73.8 | 2 | 36.9 | 0/5 |
| EXAMPLE 6 | Na₂CO₃ | 106 | 2 | 53 | 0/5 |
| COMPARATIVE | — | — | — | — | 5/5 |
| EXAMPLE 1 | | | | | |
| COMPARATIVE | C₄H₁₁N | 73 | 1 | 73 | 5/5 |
| EXAMPLE 2 | | | | | |

Corrosion occurred in all of the batteries in Comparative Examples 1 and 2, whereas no corrosion occurred in the batteries in Examples 1 to 6. In Comparative Example 2, 10 mass % of compound (C₄H₁₁N) in the coating solution had no advantageous effects, whereas in Examples 1 to 6, inclusion of 5 mass %, which is a half of 10 mass %, of a compound had advantageous effects. It is assumed that in Comparative Example 2, sufficient neutralization of hydrogen fluoride was not possible with this amount of C₄H₁₁N for the following reason. In Comparative Example 2, C₄H₁₁N indicates univalent alkaline property by coordinate bond of one proton to an amino group; however as C₄H₁₁N has a large molecular weight, a greater amount of the compound was required for neutralization of hydrogen fluoride and its volatility also decreased the addition amount.

### REFERENCE SIGNS LIST

10 secondary battery, 11 positive electrode, 12 negative electrode, 13 separator, 14 electrode assembly, 15 outer housing, 15a opening portion, 15b opening end, 16 sealing structure, 17, 18 insulating plate, 19 positive electrode lead, 20 negative electrode lead, 21 groove portion, 22 filter, 23 lower vent member, 24 insulating member, 25 upper vent member, 26 cap, 26a opening, 27 gasket, 30 opening upper region.

1. A cylindrical non-aqueous electrolyte secondary battery comprising:
a cylindrical outer housing having a bottom, the outer housing including an opening portion having a groove portion;
an electrode assembly and a non-aqueous electrolyte contained in the outer housing; and
a sealing structure caulked and fixed between the groove portion and an opening end in the opening portion, wherein
a region of an inner surface of the outer housing between the groove portion and the opening end includes powder of one or more compounds selected from a group consisting of hydroxide, oxide, and carbonate.

2. The cylindrical non-aqueous electrolyte secondary battery according to claim 1, wherein
(molecular weight)/(total number of valences of cation) of the compounds is less than or equal to 60.

3. The cylindrical non-aqueous electrolyte secondary battery according to claim 1, wherein
the compounds comprise any of aluminum hydroxide, magnesium hydroxide, aluminum oxide, magnesium oxide, lithium carbonate, or sodium carbonate.
